(19) United States
(12) Patent Application Publication
(10) Pub. No.: US 2025/0305643 A1
(43) Pub. Date: Oct. 2, 2025

(54) INTERNET OF THINGS (IOT) SYSTEMS AND METHODS OF COORDINATED CONTROL OF EQUIPMENT FOR GAS SAFETY PRESSURE REGULATION AND MEDIA

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Feng WANG, Chengdu (CN); Yunbai CHEN, Chengdu (CN); Lei ZHANG, Chengdu (CN)

(73) Assignee: CHENGDU QINCHUAN IOT TECHNOLOGY CO., LTD., Chengdu (CN)

(21) Appl. No.: 19/237,094

(22) Filed: Jun. 13, 2025

(30) Foreign Application Priority Data
May 16, 2025 (CN) 202510634016.6

(51) Int. Cl. F17D 3/00; F17D 5/00; G16Y 10/35; G16Y 40/10

(52) U.S. Cl. CPC F17D 3/00; F17D 5/005; G16Y 10/35; G16Y 40/10

(57) ABSTRACT

Provided are an IoT system and method of coordinated control of equipment for gas safety pressure regulation and a medium. The IoT system includes a government safety supervision management platform, a government safety supervision sensor network platform, a government safety supervision object platform, a gas company sensor network platform, and a gas equipment object platform. The government safety supervision object platform includes a gas company management platform. The gas equipment object platform includes a pressure regulation device and a cold energy recovery device. The gas company management platform is configured to: obtain historical sensing data from a sensing device; determine a plurality sets of sensing statistical data; and generate an adjustment instruction based on current sensing data and the sensing statistical data, the adjustment instruction being sent to the government safety supervision management platform and configured to adjust a cooling parameter and a pressure regulation parameter.

### CROSS-REFERENCE TO RELATED APPLICATIONS

This application claims priority to Chinese Patent Application No. 202510634016.6, filed on May 16, 2025, the entire content of which is hereby incorporated by reference.

### TECHNICAL FIELD

The present disclosure relates to the field of gas pressure regulation, and in particular to an Internet of Things (IoT) system and a method of coordinated control of equipment for gas safety pressure regulation and a medium.

### BACKGROUND

To ensure gas quality compliance and transportation safety, the pressure of the transported gas needs to be regulated through a gas pressure regulation station before gas enters the downstream pipeline. During pressure regulation, the change in the gas pressure often leads to a temperature variation in both the equipment and the gas. By jointly monitoring the gas pressure, the gas temperature, and the equipment temperature, coordinated control between the pressure regulation device and the cold energy recovery device of the gas pressure regulation station can be achieved, enabling the recycling of cold energy and contributing to energy conservation. However, there is currently a lack of effective means for real-time adjustment of pressure regulation parameters of the pressure regulation device and cooling parameters of the cold energy recovery device during the process of gas pressure regulation, as well as for achieving coordinated control between the pressure regulation device and the cold energy recovery device.

Therefore, it is desirable to provide an Internet of Things (IoT) system and a method of coordinated control of equipment for gas safety pressure regulation and a medium, which can guarantee the efficient operation of the gas pressure regulation station by adjusting the pressure regulation parameters of the pressure regulation device and the cooling parameters of the cold energy recovery device in time, thereby ensuring safe and stable gas transportation.

### SUMMARY

One or more embodiments of the present disclosure provide an Internet of Things (IoT) system of coordinated control of equipment for gas safety pressure regulation, comprising a government safety supervision management platform, a government safety supervision sensor network platform, a government safety supervision object platform, a gas company sensor network platform, and a gas equipment object platform. The government safety supervision object platform includes a gas company management platform. The gas equipment object platform includes a pressure regulation device and a cold energy recovery device. The pressure regulation device and the cold energy recovery device are provided with a sensing device. The pressure regulation device is disposed in a gas pressure regulation station. The gas company management platform is configured to implement a method of coordinated control of equipment for gas safety pressure regulation.

One or more embodiments of the present disclosure provide a method of coordinated control of equipment for gas safety pressure regulation, the method comprising: obtaining historical sensing data from a sensing device, the historical sensing data including sensing data at a plurality of historical moments, the sensing data including a first pressure before gas passes through a pressure regulation device, a second pressure after the gas passes through the pressure regulation device, a gas temperature, and a device temperature of the pressure regulation device; determining a plurality sets of sensing statistical data based on the historical sensing data, the sensing statistical data including a pressure difference statistic and a temperature difference statistic; and generating an adjustment instruction based on current sensing data and the sensing statistical data, the adjustment instruction being sent to a government safety supervision management platform and configured to adjust a cooling parameter of a cold energy recovery device and a pressure regulation parameter of the pressure regulation device.

One or more embodiments of the present disclosure provide a non-transitory computer-readable storage medium, comprising computer instructions that, when read by a computer, direct the computer to implement the method of coordinated control of equipment for gas safety pressure regulation.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an exemplary platform structure of an IoT system of coordinated control of equipment for gas safety pressure regulation according to some embodiments of the present disclosure;

FIG. 2 is a flowchart illustrating an exemplary method of coordinated control of equipment for gas safety pressure regulation according to some embodiments of the present disclosure;

FIG. 3 is a flowchart illustrating an exemplary process of determining a plurality sets of sensing statistical data according to some embodiments of the present disclosure;

FIG. 4 is a flowchart illustrating an exemplary process of determining a pressure regulation parameter at a first moment according to some embodiments of the present disclosure; and

FIG. 5 is schematic diagram illustrating an exemplary pressure difference model according to some embodiments of the present disclosure.

### DETAILED DESCRIPTION

The accompanying drawings, which are required to be used in the description of the embodiments, are briefly described below. The accompanying drawings do not represent the entirety of the embodiments.

When describing operations performed step-by-step in the embodiments of the present disclosure, unless otherwise specified, the order of the operations may be adjusted, operations may be omitted, and additional steps may be included in the processes.

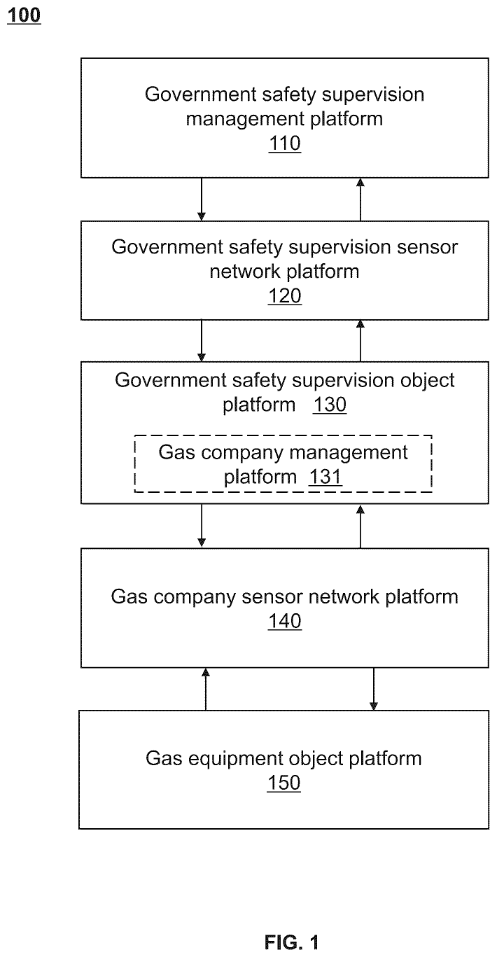

FIG. 1 is a schematic diagram illustrating an exemplary platform structure of an IoT system of coordinated control of equipment for gas safety pressure regulation according to some embodiments of the present disclosure.

In some embodiments, as shown in FIG. 1, an IoT system 100 of coordinated control of equipment for gas safety pressure regulation includes a government safety supervision management platform 110, a government safety supervision sensor network platform 120, a government safety supervision object platform 130, a gas company sensor network platform 140, and a gas equipment object platform 150.

The government safety supervision management platform 110 refers to a platform for supervision and safety management of a gas pipeline network. In some embodiments, the government safety supervision management platform 110 coordinates connections and collaborations between various functional platforms, aggregates all IoT information, and provides perception management and control management functions for an IoT operation system.

The government safety supervision sensor network platform 120 refers to a platform for managing sensor communication for government entities and configured as a communication network or a gateway.

In some embodiments, the government safety supervision sensor network platform 120 interacts upward with the government safety supervision management platform 110 and downward with the government safety supervision object platform 130. For example, the government safety supervision object platform 130 sends an adjustment instruction to the government safety supervision management platform 110 through the government safety supervision sensor network platform 120.

The government safety supervision object platform 130 refers to an object platform for perception information generation and control information execution.

In some embodiments, the government safety supervision object platform 130 includes a gas company management platform 131.

The gas company management platform 131 refers to a comprehensive management platform for information related to a gas company. In some embodiments, the gas company management platform 131 is configured to implement a method of coordinated control of equipment for gas safety pressure regulation.

In some embodiments, the gas company management platform 131 further includes a processor. The processor may include one or more sub-processing devices (e.g., a single-core processing device or a multi-core processing device). Merely by way of example, the processor includes a central processing unit (CPU), an application-specific integrated circuit (ASIC), or the like, or any combination thereof.

The gas company sensor network platform 140 refers to a comprehensive management platform for sensor information of the gas company and configured as a communication network or a gateway to realize functions of perception information sensor communication and control information sensor communication.

In some embodiments, the gas company sensor network platform 140 interacts upward with the government safety supervision object platform 130 and downward with the gas equipment object platform 150. For example, the government safety supervision object platform 130 sends the adjustment instruction to the gas equipment object platform 150 via the gas company sensor network platform 140.

The gas equipment object platform 150 refers to a functional platform for executing temperature and pressure monitoring and equipment parameter adjustment. In some embodiments, the gas equipment object platform 150 includes a pressure regulation device and a cold energy recovery device.

The pressure regulation device refers to a device capable of performing gas pressure regulation. In some embodiments, the gas equipment object platform further includes a plurality of input pipelines of a gas pressure regulation station. The pressure regulation device may include a distribution device, a pressurization device, and/or a depressurization device.

The gas pressure regulation station refers to a station for gas pressure regulation. In some embodiments, the gas pressure regulation station includes the input pipelines, the pressure regulation device, etc.

The input pipelines refer to pipelines conveying gas into the gas pressure regulation station.

The distribution device refers to a device for distributing gas to different paths. The distribution device may have a plurality of functions including flow control, pressure balancing, and path selection for distributing the gas from different input pipelines to different processing paths (e.g., a pressurization path, a depressurization path, or a direct output path) according to a specific rule or proportion. In some embodiments, the distribution device is a distribution valve for distributing the gas from a plurality of input pipelines to the pressurization device and the depressurization device.

The pressurization device refers to a device for increasing a gas pressure, such as a compressor. When the gas pressure of the gas from the input pipelines is lower than a target output pressure, the pressurization device is activated to increase the gas pressure by enhancing gas energy (e.g., compressing a gas volume), so as to meet subsequent gas transportation or usage requirements.

The depressurization device refers to a device for reducing the gas pressure, such as a pressure regulation valve. When the gas pressure of the gas from the input pipelines exceeds the target output pressure or needs reduction for safety, efficiency, or the like, the depressurization device is activated to decrease the gas pressure by reducing the gas energy (e.g., expanding the gas volume), so as to ensure safe and stable gas transportation to the gas pipeline network.

The cold energy recovery device refers to a device for recovering a refrigerant. The refrigerant refers to a medium capable of lowering temperature, such as propane, cooling water, etc. In some embodiments, the cold energy recovery device includes a refrigerant circulation pipeline. The refrigerant circulation pipeline refers to a pipeline through which the refrigerant circulates or flows.

In some embodiments, the pressure regulation device and the cold energy recovery device are provided with a sensing device.

The sensing device refers to a device for monitoring gas or device sensing data. In some embodiments, the sensing device includes a pressure sensor, a temperature sensor, etc. In some embodiments, the sensing device is disposed at an appropriate position on a gas pipeline, the pressure regulation device, and the cold energy recovery device according to a monitoring requirement. For example, the pressure sensor and the temperature sensor are disposed near an inlet/outlet position of the pressure regulation device, while the temperature sensor is disposed on an outer surface of the pressure regulation device.

In some embodiments, the cold energy recovery device further includes an expansion refrigeration device.

The expansion refrigeration device refers to a device for providing a refrigeration effect utilizing cold energy released during depressurization and expansion, such as a turbo-expander, a piston expander, etc.

In some embodiments, the expansion refrigeration device is connected with the depressurization device to directly convert gas pressure energy generated by the depressurization device into cold energy without additional energy consumption, thereby achieving energy-efficient refrigeration.

In some embodiments of the present disclosure, the IoT system 100 of coordinated control of equipment for gas safety pressure regulation can form a closed loop of information operation between functional platforms, and achieve coordinated and regular operation under unified management of the gas company management platform, thereby realizing informatization and intelligentization of pressure and temperature regulation of smart gas.

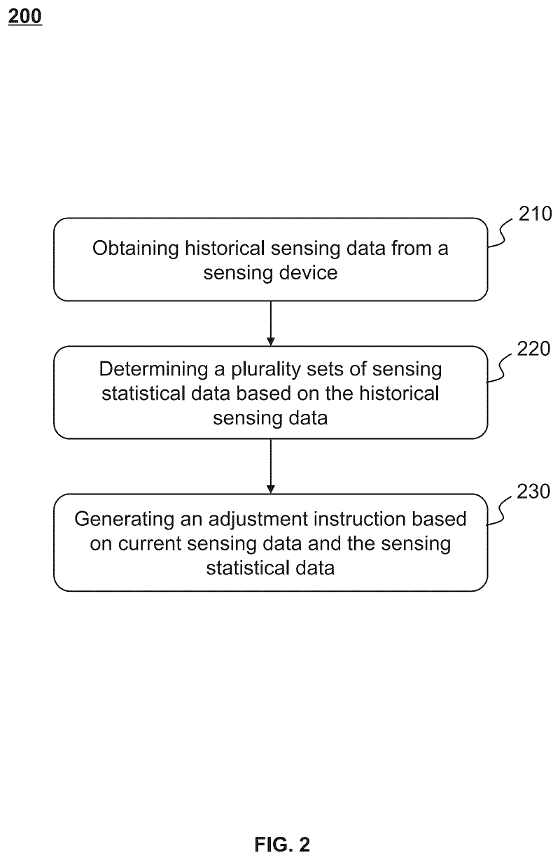

FIG. 2 is a flowchart illustrating an exemplary method of coordinated control of equipment for gas safety pressure regulation according to some embodiments of the present disclosure. As shown in FIG. 2, a process 200 includes the following steps 210-230.

In some embodiments, the process 200 is performed by the gas company management platform 131. For example, the process 200 is performed by a processor in the gas company management platform 131.

Step 210, obtaining historical sensing data from a sensing device.

The sensing data refers to data related to gas pressure regulation acquired by the sensing device. In some embodiments, the sensing data includes a first pressure before gas passes through a pressure regulation device, a second pressure after the gas passes through the pressure regulation device, a gas temperature, and a device temperature of the pressure regulation device.

The first pressure refers to a gas pressure before regulation by the pressure regulation device.

The second pressure refers to a gas pressure after regulation by the pressure regulation device.

The gas temperature refers to a temperature of the gas after passing through the pressure regulation device.

The device temperature refers to a temperature of the pressure regulation device.

In some embodiments, the sensing data is obtained by the sensing device through real-time monitoring. For example, the first pressure is obtained by a pressure sensor disposed at or near an inlet of the pressure regulation device, the second pressure and the gas temperature are respectively obtained by a pressure sensor and a temperature sensor disposed at or near an outlet of the pressure regulation device, and the device temperature is obtained by a temperature sensor disposed on an outer surface of the pressure regulation device.

In some embodiments, the historical sensing data includes sensing data at a plurality of historical moments. The historical moments refer to moments in time prior to a current moment, such as a plurality of moments during a day one week ago.

Merely by way of example, the historical sensing data is represented in the following Table (1):

TABLE 1

| | Historical sensing data | | | |
|---|---|---|---|---|
| | Historical | Historical | Historical | Historical |
| Historical | first | second | gas | device |
| moment | pressure | pressure | temperature | temperature |
| t₁ | A₁ | B₁ | C₁ | D₁ |
| t₂ | A₂ | B₂ | C₂ | D₂ |
| . . . | . . . | . . . | . . . | . . . |
| tₙ | Aₙ | Bₙ | Cₙ | Dₙ |

Where tₙ represents an n-th historical moment, and Aₙ, Bₙ, Cₙ, and Dₙ respectively represent a historical first pressure, a historical second pressure, a historical gas temperature, and a historical device temperature at a historical moment tₙ.

In some embodiments, the sensing data is monitored and acquired by the sensing device, uploaded to a gas company management platform through a gas company sensor network platform, and the processor y directly retrieves the historical sensing data.

Step 220, determining a plurality sets of sensing statistical data based on the historical sensing data.

The sensing statistical data refers to statistical data related to a change in the historical sensing data. In some embodiments, the sensing statistical data includes a pressure difference statistic and a temperature difference statistic. A set of sensing statistical data may include a pressure difference statistic and a temperature difference statistic corresponding to a set of historical sensing data.

In some embodiments, the processor determines the plurality sets of historical sensing data by dividing the historical sensing data into intervals. For each set of historical sensing data, the sensing statistical data may be calculated. More descriptions may be found in the present disclosure below.

The pressure difference statistic refers to statistical data related to a change in a gas pressure. In some embodiments, the pressure difference statistic includes an extremum of a pressure change rate, a median of the pressure change rate, etc.

The pressure change rate refers to a rate of pressure change. In some embodiments, the pressure change rate is represented as a ratio of the pressure change to a time duration corresponding to the pressure change. The extremum of a pressure change rate may include maximum and/or minimum values of a plurality of pressure change rates, and the median of the pressure change rate may be a median of the plurality of the pressure change rates.

The temperature difference statistic refers to statistical data related to a change in the gas temperature and/or the device temperature. In some embodiments, the temperature difference statistic includes an extremum of a gas temperature change rate, a median of the gas temperature change rate, an extremum of a device temperature change rate, a median of the device temperature change rate, etc.

The temperature change rate refers to a rate of temperature change. The gas temperature change rate and the device temperature change rate respectively refer to a temperature change rate of the gas temperature and a temperature change rate of the device temperature.

In some embodiments, the temperature change rate is represented as a ratio of the temperature change to a time duration corresponding to the temperature change. The extremum of the temperature change rate may include maximum and/or minimum values of a plurality of temperature change rates, and the median of the temperature change rate may be a median of the plurality of temperature change rates. A positive temperature change rate indicates an increase in the device temperature and/or the gas temperature; a negative temperature change rate indicates a decrease in the device temperature and/or the gas temperature. When the device temperature and/or the gas temperature decreases, a cold energy recovery device does not operate.

In some embodiments, the processor may determine the plurality sets of sensing statistical data based on the historical sensing data in various ways.

For example, the processor determines the plurality sets of sensing statistical data based on the historical sensing data through statistical analysis, which specifically includes the following steps S11-S13:

Step S11, dividing a historical first pressure into intervals, and grouping the historical sensing data into a plurality of clusters.

In some embodiments, the processor divides a plurality of historical first pressures at a plurality of historical moments into different intervals based on a preset pressure step, and group the plurality of the historical sensing data corresponding to each historical first pressure interval into a cluster. The preset pressure step may be a default processor setting or preset by those skills in the art based on experience.

For example, if the historical first pressure is in a range of 1 MPa-5 MPa and the preset pressure step is 1 MPa, the historical first pressure is divided into intervals: [1 MPa, 2 MPa), [2 MPa, 3 MPa), [3 MPa, 4 MPa), [4 MPa, 5 MPa], and the historical sensing data corresponding to each historical first pressure interval is grouped into each cluster.

Step S12, for the historical sensing data of each cluster, calculating a plurality of historical pressure change rates within the cluster, and dividing each cluster into a plurality sets of historical sensing data by dividing the plurality of historical pressure change rates within the cluster into intervals.

In some embodiments, for the historical sensing data of each cluster, two adjacent historical moments form a historical time period. The historical sensing data of each cluster may include a plurality of historical time periods, and a plurality of corresponding historical pressure change rates may be calculated. For one historical time period, the processor may calculate a corresponding historical pressure change rate based on a historical first pressure at a start historical moment and a historical second pressure at an end historical moment. For example, referring to Table (1), the historical first pressure at a historical moment t₁ is A₁ and the historical second pressure at a historical moment t₂ is B₂, a historical pressure change of a historical time period t₁-t₂ is B₂-A₁, and a corresponding historical pressure change rate is

$$\frac{{B}_{2} - {A}_{1}}{{t}_{2} - {t}_{1}} .$$

In some embodiments, the processor divides the plurality of historical pressure change rates within each cluster into different intervals based on a preset change rate step, and group a plurality pieces of historical sensing data corresponding to each historical pressure change rate interval into a set. The preset change rate step may be a default processor setting or preset by those skilled based on experience.

For example, for a cluster of historical sensing data with a historical first pressure interval [1 MPa, 2 MPa), the corresponding historical pressure change rate is in a range of [0.1 MPa/s, 0.4 MPa/s] and the preset change rate step is 0.1 MPa/s, the historical pressure change rate is divided into intervals: [0.1 MPa/s, 0.2 MPa/s), [0.2 MPa/s, 0.3 MPa/s), [0.3 MPa/s, 0.4 MPa/s). The historical sensing data corresponding to each historical pressure change rate interval is grouped into a set. That is, the cluster of historical sensing data with the historical first pressure interval [1 MPa, 2 MPa) is subdivided into 3 sets based on the historical pressure change rate.

Merely by way of example, referring to Table (2) below, for a cluster of historical sensing data corresponding to a historical first pressure interval [a₁−b₁] with a corresponding historical pressure change rate being in a range of [vₐ₁−v_{b1}], the processor divides the historical pressure change rate into 2 sets [vₐ₁−v_{ab1}] and [v_{ab1}−v_{b1}] based on the preset change rate step, and group the historical sensing data corresponding to the two historical pressure change rate intervals into two sets, respectively.

The grouping of one cluster of historical sensing data into a plurality of sets may be represented by the following Table (2). Each historical first pressure interval corresponds to a cluster of historical sensing data, and within each cluster, each historical pressure change rate interval corresponds to a set of a plurality pieces of historical sensing data.

TABLE (2)

| | Historical | Historical | Historical | | |
|---|---|---|---|---|---|
| Historical | first | pressure | pressure | | |
| time | pressure | change | change rate | Cluster and set | |
| period | interval | rate | interval | description | |
| t₁-t₂ | [a₁ − b₁] | ${v}_{12} = \frac{{B}_{2} - {A}_{1}}{{t}_{2} - {t}_{1}}$ | [vₐ₁ − v_{ab1}] | Cluster 1 | Set 1 of Cluster 1 |
| t₂-t₃ | | ${v}_{23} = \frac{{B}_{3} - {A}_{2}}{{t}_{3} - {t}_{2}}$ | | | |
| t₃-t₄ | | ${v}_{34} = \frac{{B}_{4} - {A}_{3}}{{t}_{4} - {t}_{3}}$ | [v_{ab1} − v_{b1}] | | Set 2 of Cluster 1 |
| t₄-t₅ | | ${v}_{45} = \frac{{B}_{5} - {A}_{4}}{{t}_{5} - {t}_{4}}$ | | | |
| t₅-t₆ | [a₂ − b₂] | ${v}_{56} = \frac{{B}_{6} - {A}_{5}}{{t}_{6} - {t}_{5}}$ | [vₐ₂ − v_{ab2}] | Cluster 2 | Set 1 of Cluster 2 |
| . . . | | . . . | . . . | | . . . |
| . . . | | . . . | . . . | . . . | . . . |
| . . . | . . . | . . . | | | |
| . . . | [aᵢ − bᵢ] | . . . | . . . | Cluster | . . . |
| . . . | | . . . | [v_{ab(j-1)} − v_{bi}] | i | Set j of |
| tₙ₋₁-tₙ | | ${v}_{( n - 1 ) n} = \frac{{B}_{n} - {A}_{n - 1}}{{t}_{n} - {t}_{n - 1}}$ | | | Cluster i |

Where a₁, a₂, . . . , aᵢ represent minimum values of historical first pressures of different historical first pressure intervals; b₁, b₂, . . . , bᵢ represent maximum values of historical first pressures of different historical first pressure intervals; [aᵢ−bᵢ] represents an i-th historical first pressure interval; A₁, A₂, . . . , Aₙ₋₁ represent historical first pressures at historical moments t₁, t₂, . . . , tₙ₋₁; b₂, b₃, . . . , bₙ represent historical second pressures at historical moments t₂, t₃, . . . , tₙ; v₁₂, v₂₃, . . . , v₍ₙ₋₁₎ₙ represent historical pressure change rates of corresponding historical time periods t₁-t₂, t₂-t₃, . . . , tₙ₋₁-tₙ; [vₐ₁−v_{ab1}] represents a historical pressure change rate interval for Set 1 of Cluster 1; [v_{ab(j-1)}−v_{bi}] represents a historical pressure change rate interval for Set j of Cluster i.

Step S13, for each set of historical sensing data, calculating sensing statistical data of the set of historical sensing data.

In some embodiments, for each set of historical sensing data, the processor determines a plurality of historical pressure change rates, historical gas temperature change rates, and historical device temperature change rates corresponding to the set of historical sensing data. Calculation processes for the historical gas temperature change rates and the historical device temperature change rates may be found in the calculation processes for the historical pressure change rates in the step S12, which are not repeated there.

In some embodiments, the processor determines medians and extremums of the historical pressure change rates, medians and extremums of the historical gas temperature change rates, and medians and extremums of the historical device temperature change rates through statistical analysis, thereby determining a set of sensing statistical data for the set of historical sensing data.

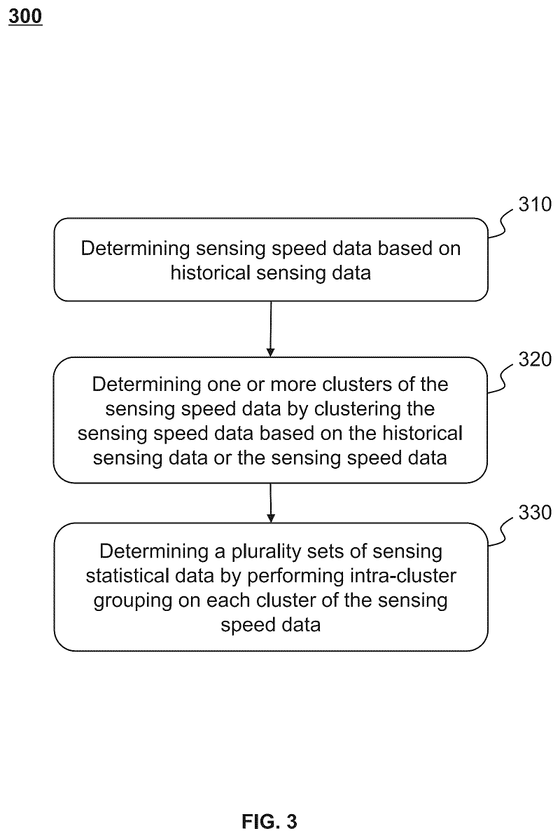

In some embodiments, the processor determines sensing speed data based on the historical sensing data; determines one or more clusters of sensing speed data by clustering the sensing speed data based on the historical sensing data or the sensing speed data; determine the plurality sets of sensing statistical data by performing intra-cluster grouping on each cluster of the sensing speed data. More descriptions may be found in FIG. 3 and related descriptions thereof.

Step 230, generating an adjustment instruction based on current sensing data and the sensing statistical data.

The current sensing data refers to sensing data of a current time period, the current time period being a relatively short time period prior to a current moment (e.g., last 5 min, 10 min, or the like, prior to the current moment). The current sensing data may include sensing data of two or more time points within the current time period.

In some embodiments, the current sensing data is acquired by the sensing device, uploaded to the gas company management platform via the gas company sensor network platform, and directly retrieved by the processor.

The adjustment instruction refers to an instruction for adjusting a parameter of equipment in the gas equipment object platform.

In some embodiments, the adjustment instruction is sent to the government safety supervision management platform by the gas company management platform and configured to adjust a cooling parameter of the cold energy recovery device and a pressure regulation parameter of the pressure regulation device.

In some embodiments, the adjustment instruction includes a target cooling parameter and a target pressure regulation parameter.

The cooling parameter refers to an operation parameter of the cold energy recovery device. In some embodiments, the cooling parameter includes a cooling operation power, a refrigerant circulation speed, or the like, of the cold energy recovery device. The refrigerant circulation speed may be measured by a volume/mass of a fluid passing through a circulation system per unit time.

The target cooling parameter refers to a cooling parameter required by the cold energy recovery device, including a target cooling operation power and a target refrigerant circulation speed.

The pressure regulation parameter refers to an operation parameter of the pressure regulation device. In some embodiments, the pressure regulation parameter includes a pressure regulation operation power and a pressure valve opening of the pressure regulation device.

The pressure regulation operation power refers to an operation power when the pressure regulation device performs gas pressure regulation.

The pressure valve opening refers to an opening degree of a pressure regulation valve within the pressure regulation device. In some embodiments, the larger the pressure valve opening, the greater the opening degree of the pressure regulation valve, the larger the passage through which the gas flows when passing through the valve, the greater the reduction in the gas pressure.

The target pressure regulation parameter refers to a required pressure regulation parameter of the pressure regulation device, including a target pressure regulation operation power, a target pressure valve opening, etc.

In some embodiments, the processor generates the adjustment instruction based on the current sensing data and the sensing statistical data through the following steps S21-S25:

Step S21, determining a current pressure change rate and a current temperature change rate based on the current sensing data.

In some embodiments, the processor calculates the current pressure change rate and the current temperature change rate within the current time period based on the current sensing data of two time points within the current time period. The calculation manners for the current pressure change rate and the current temperature change rate are similar to the calculation manners for the historical pressure change rate and the historical temperature change rate. More descriptions may be found in the step S12 and the step S13, which are not reiterated here.

Step S22, determining current statistical data based on a current first pressure, the current pressure change rate, and the historical sensing data.

The current statistical data refers to statistical data of the current sensing data. In some embodiments, the processor determines a corresponding cluster of historical sensing data by determining a historical first pressure interval to which the current first pressure belongs; determines a corresponding set of historical sensing data by determining a historical pressure change rate interval to which the current pressure change rate belongs in the cluster of historical sensing data; and determines the sensing statistical data corresponding to the set of historical sensing data as the current statistical data.

Step S23, comparing the current temperature change rate with the current statistical data, in response to determining that a preset condition is met, determining a target cooling parameter based on the current temperature change rate, the preset condition being that the current gas temperature change rate is greater than a median of the gas temperature change rate in the current statistical data, and/or the current device temperature change rate is greater than a median of the device temperature change rate in the current statistical data.

It is understood that the current temperature change rate being greater than the median of the historical temperature change rate indicates that current temperature rise is excessive and the temperature of the pressure regulation device needs to be reduced by adjusting the cooling parameter of the cold energy recovery device.

In some embodiments, in response to determining that the current temperature change rate meets the preset condition, the processor determines the target cooling parameter by querying a first preset lookup table based on the current temperature change rate. The first preset lookup table may include a correspondence between the temperature change rate and the cooling parameter. The first preset lookup table typically may be constructed by those skilled in the art based on historical data or experience.

In some embodiments, the processor determines a cooling parameter corresponding to a temperature change rate with a highest similarity to the current temperature change rate in the first preset lookup table as the target cooling parameter. The similarity may be represented by an absolute value of a difference between the current temperature change rate and the temperature change rate in the table. The smaller the absolute value of the difference, the higher the similarity. In some embodiments, the processor prioritizes adjustment to the cooling parameter of the cold energy recovery device based on the difference between the current cooling parameter and the target cooling parameter.

Step S24, in response to determining that the temperature change rate meets the preset condition after cooling for a preset time period based on the target cooling parameter, determining the target pressure regulation parameter based on a device temperature after the preset time period.

The preset time period refers to a time period during which the cooling energy recovery device operates based on the target cooling parameter after the current moment. The preset time period may be set by those skilled in the art based on historical experience. In some embodiments, the processor determines a pressure regulation operation efficiency based on the device temperature after the preset time period by querying a second preset lookup table; and determines the target pressure regulation parameter based on the current pressure regulation parameter and the pressure regulation operation efficiency. The second preset lookup table may include a correspondence between the device temperature and the pressure regulation operation efficiency. The pressure regulation operation efficiency refers to an efficiency of the pressure regulation device performing gas pressure regulation, and is represented by a ratio of an actual operation capacity to a theoretical operation capability of the pressure regulation device. For example, the pressure regulation operation efficiency being 80% indicates that a ratio of an output power to an input power of the pressure regulation device is 80%. In some embodiments, the pressure regulation operation efficiency is negatively correlated with the device temperature.

For example, the processor retrieves a pressure regulation operation efficiency corresponding to the device temperature after the preset time period from the second preset lookup table, and determines a ratio of a current pressure regulation operation power to the pressure regulation operation efficiency as the target pressure regulation operation power.

Step S25, generating the adjustment instruction based on the target cooling parameter and the target pressure regulation parameter.

In some embodiments, the processor inputs the target cooling parameter and the target pressure regulation parameter into a preset template of the adjustment instruction to automatically generate the adjustment instruction.

In some embodiments of the present disclosure, by statistical analysis of the historical sensing data, the sensing statistical data can be determined, and change patterns of the gas pressure, the device temperature, and the gas temperature can be evaluated. By grouping the sensing statistical data, the gas can be divided into different intervals, which facilitates different degrees of pressure regulation and cooling operations for the gas of different pressures, thereby maintaining relatively good operation efficiency of the pressure regulation device and the cold energy recovery device.

FIG. 3 is a flowchart illustrating an exemplary process of determining a plurality sets of sensing statistical data according to some embodiments of the present disclosure. As shown in FIG. 3, a process 300 may include steps 310-330. In some embodiments, the process 300 is performed by the gas company management platform 131. For example, the process 300 is performed by the processor in the gas company management platform 131.

Step 310, determining sensing speed data based on historical sensing data.

The sensing speed data refers to data related to a rate of change of the historical sensing data. The sensing speed data may include pressure change rates and temperature change rates of a plurality of historical time periods.

The historical time period refers to a time period formed by two adjacent historical moments. More descriptions regarding the historical sensing data, the historical moments, the pressure change rate, and the temperature change rate may be found in FIG. 2 and the related descriptions thereof.

In some embodiments, the processor determines the sensing speed data based on the historical sensing data. More descriptions may be found in the related descriptions of the step S12 and the step S13.

Step 320, determining one or more clusters of the sensing speed data by clustering the sensing speed data based on the historical sensing data or the sensing speed data.

Merely by way of example, continuing with the Table (2), the one or more clusters of the sensing speed data are represented by the following Table (3), where each historical first pressure interval corresponds to one cluster of a plurality pieces of sensing speed data.

TABLE (3)

| | | Sensing speed data | | | |
|---|---|---|---|---|---|
| | Historical | | Historical temperature change rate | | |
| Historical | first | Historical | Historical gas | Historical device | |
| time | pressure | pressure | temperature | temperature | Cluster |
| period | interval | change rate | change rate | change rate | description |
| t₁-t₂ | [a₁ − b₁] | ${v}_{12} = \frac{{B}_{2} - {A}_{1}}{{t}_{2} - {t}_{1}}$ | $w {r}_{12} = \frac{{C}_{2} - {C}_{1}}{{t}_{2} - {t}_{1}}$ | $w {s}_{12} = \frac{{D}_{2} - {D}_{1}}{{t}_{2} - {t}_{1}}$ | Cluster 1 |
| t₂-t₃ | | ${v}_{23} = \frac{{B}_{3} - {A}_{2}}{{t}_{3} - {t}_{2}}$ | $w {r}_{23} = \frac{{C}_{3} - {C}_{2}}{{t}_{3} - {t}_{2}}$ | $w {s}_{23} = \frac{{D}_{3} - {D}_{2}}{{t}_{3} - {t}_{2}}$ | |
| t₃-t₄ | | ${v}_{34} = \frac{{B}_{4} - {A}_{3}}{{t}_{4} - {t}_{3}}$ | $w {r}_{34} = \frac{{C}_{4} - {C}_{3}}{{t}_{4} - {t}_{3}}$ | $w {s}_{34} = \frac{{D}_{4} - {D}_{3}}{{t}_{4} - {t}_{3}}$ | |
| t₄-t₅ | | ${v}_{45} = \frac{{B}_{5} - {A}_{4}}{{t}_{5} - {t}_{4}}$ | $w {r}_{45} = \frac{{C}_{5} - {C}_{4}}{{t}_{5} - {t}_{4}}$ | $w {s}_{45} = \frac{{D}_{5} - {D}_{4}}{{t}_{5} - {t}_{4}}$ | |
| t₅-t₆ | [a₂ − b₂] | ${v}_{56} = \frac{{B}_{6} - {A}_{5}}{{t}_{6} - {t}_{5}}$ | $w {r}_{56} = \frac{{C}_{6} - {C}_{5}}{{t}_{6} - {t}_{5}}$ | $w {s}_{56} = \frac{{D}_{6} - {D}_{5}}{{t}_{6} - {t}_{5}}$ | . . . |
| . . . | . . . | . . . | . . . | . . . | . . . |
| . . . | [aᵢ − bᵢ] | . . . | . . . | . . . | |
| tₙ₋₁-tₙ | | ${v}_{( n - 1 ) n} = \frac{{B}_{n} - {A}_{n - 1}}{{t}_{n} - {t}_{n - 1}}$ | $w {r}_{( n - 1 ) n} = \frac{{C}_{n} - {C}_{n - 1}}{{t}_{n} - {t}_{n - 1}}$ | $w {s}_{( n - 1 ) n} = \frac{{D}_{n} - {D}_{n - 1}}{{t}_{n} - {t}_{n - 1}}$ | Cluster i |

Where wr₁₂, wr₂₃, . . . , wr₍ₙ₋₁₎ₙ represent historical gas temperature change rates of the historical time periods t₁-t₂, t₂-t₃, . . . , tₙ₋₁-tₙ, respectively; C₁, C₂, . . . , Cₙ represent historical gas temperatures at the historical moments t₁, t₂, . . . , tₙ₋₁, respectively; ws₁₂, ws₂₃, . . . , ws₍ₙ₋₁₎ₙ represent historical device temperature change rates of the historical time periods t₁-t₂, t₂-t₃, . . . , tₙ₋₁-tₙ, respectively; D₁, D₂, . . . Dₙ represent historical device temperatures at the historical moments t₁, t₂, . . . , tₙ₋₁, respectively. More descriptions regarding other parameters may be found in Table (1) and Table (2).

The one or more clusters of the sensing speed data refer to sensing speed data corresponding to each cluster of historical sensing data after clustering. One cluster of historical sensing data may correspond to one cluster of sensing speed data.

In some embodiments, the processor clusters the sensing speed data into one or more clusters of sensing speed data based on the historical first pressures in the historical sensing data. More descriptions may be found in the steps S11-S13 and the related descriptions thereof.

In some embodiments, the processor determines clustering features based on the sensing speed data, and determine the one or more clusters of the sensing speed data by clustering the clustering features.

The clustering features refer to basis features for clustering the sensing speed data. A piece of sensing speed data of a historical time period may correspond to a clustering feature. Taking the sensing speed data of the historical time period t₁-t₂ as an example, the processor determines the corresponding clustering feature through the following formula (1):

$${H}_{12} = \frac{{wr}_{12}}{{v}_{12}} + \frac{{ws}_{12}}{{v}_{12}} \qquad ( 1 )$$

Where v₁₂, wr₁₂, ws₁₂ represent a historical pressure change rate, a historical gas temperature change rate, and a historical device temperature change rate of the historical time period t₁-t₂, respectively, and H₁₂ represents a clustering feature of v₁₂.

In some embodiments, the processor clusters a plurality of clustering features, and determines sensing speed data corresponding to clustering features of a same cluster in a clustering result as a cluster of sensing speed data, sensing speed data corresponding to a plurality clusters of clustering features being a plurality clusters of sensing speed data. The clustering manners may include but are not limited to mean shift clustering, etc.

Step 330, determining a plurality sets of sensing statistical data by performing intra-cluster grouping on each cluster of the sensing speed data.

In some embodiments, the processor divides the plurality of historical pressure change rates within each cluster of sensing speed data into intervals, divides one cluster of sensing speed data into a plurality of sets, and calculates the sensing statistical data of each set. More descriptions may be found in the related descriptions of the steps S12-S13.

Merely by way of example, continuing with Table (2) and Table (3), the plurality sets of sensing statistical data corresponding to one or more clusters of sensing speed data after intra-cluster grouping are represented by the following Table (4):

TABLE (4)

| | Sensing speed data | | | | | |
|---|---|---|---|---|---|---|
| | | Historical | | | | |
| | | temperature | | | | |
| | | change rate | | | | |
| | | Historical | Historical | | | |
| | Historical | gas | device | | Sensing statistical data | |
| Historical | pressure | temperature | temperature | Cluster | Pressure | |
| time | change | change | change | and set | difference | Temperature |
| period | rate | rate | rate | description | statistic | difference statistic |
| t₁-t₂ | v₁₂ | wr₁₂ | ws₁₂ | Set 1 of Cluster 1 | $( {v}_{m ax}^{11} , {v}_{m i n}^{11} , {v}_{med}^{11} )$ | $( w {r}_{ma x}^{11} , {wr}_{m i n}^{11} , {wr}_{m e d}^{11} ) \\ ( w {s}_{ma x}^{11} , {ws}_{m i n}^{11} , {ws}_{m e d}^{11} )$ |
| t₂-t₃ | v₂₃ | wr₂₃ | ws₂₃ | | | |
| t₃-t₄ t₄-t₅ | v₃₄ v₄₅ | wr₃₄ wr₄₅ | ws₃₄ ws₄₅ | Set 2 of Cluster 1 | $( {v}_{m ax}^{12} , {v}_{m i n}^{12} , {v}_{med}^{12} )$ | $( w {r}_{ma x}^{12} , {wr}_{m i n}^{12} , {wr}_{m e d}^{12} ) \\ ( w {s}_{ma x}^{12} , {ws}_{m i n}^{12} , {ws}_{m e d}^{12} )$ |
| . . . | . . . | . . . | . . . | . . . | . . . | . . . |
| . . . | . . . | . . . | . . . | . . . | . . . | . . . |
| tₙ₋₁-tₙ | v₍ₙ₋₁₎ | wr₍ₙ₋₁₎ₙ | ws₍ₙ₋₁₎ₙ | Set j of Cluster i | $( {v}_{m ax}^{ij} , {v}_{m i n}^{ij} , {v}_{med}^{ij} )$ | $( {wr}_{m ax}^{ij} , {wr}_{m i n}^{ij} , {wr}_{med}^{ij} ) \\ ( {ws}_{m ax}^{ij} , {ws}_{m i n}^{ij} , {ws}_{m ed}^{ij} )$ |

Where

$$( {v}_{m ax}^{ij} , {v}_{m i n}^{ij} , {v}_{med}^{ij} )$$

represents a pressure difference statistic corresponding to a j-th set of sensing speed data in an i-th cluster,

$${v}_{m ax}^{ij} , {v}_{m i n}^{ij} , {v}_{med}^{ij}$$

represent a maximum value, a minimum value, and a median of the historical pressure change rates, respectively;

$$( {wr}_{m ax}^{ij} , {wr}_{m i n}^{ij} , {wr}_{med}^{ij} ) and ( {ws}_{m ax}^{ij} , {ws}_{m i n}^{ij} , {ws}_{med}^{ij} )$$

represent a gas temperature statistic and a device temperature statistic corresponding to the j-th set of sensing speed data in the i-th cluster, respectively,

$${wr}_{m ax}^{ij} , {wr}_{m i n}^{ij} , {wr}_{med}^{ij}$$

represent a maximum value, a minimum value, and a median of the historical gas temperature change rates, respectively;

$${ws}_{m ax}^{ij} , {ws}_{m i n}^{ij} and {ws}_{med}^{ij}$$

represent a maximum value, a minimum value, and a median of the historical device temperature change rates, respectively. More descriptions regarding other parameters may be found in Tables (1), (2), and (3).

In some embodiments, for each cluster of the sensing speed data: the processor determines a plurality sets of sensing speed data by performing intra-cluster grouping on the sensing speed data based on historical adjustment time points of the pressure regulation parameter and the cooling parameter; and determines the plurality sets of sensing statistical data based on the plurality sets of sensing speed data.

More descriptions regarding the pressure regulation parameter and cooling parameter may be found in the related descriptions of FIG. 2.

The historical adjustment time points refer to historical time points when the pressure regulation parameter and/or the cooling parameter changes. In some embodiments, the historical adjustment time points are historical time points within an acquisition time period corresponding to the historical sensing data.

In some embodiments, the historical adjustment time points are obtained by the processor or those skilled in the art based on historical data. For example, if the historical sensing data includes sensing data from a historical moment t₁ to a historical moment tₙ, the acquisition time period of the historical sensing data is t₁-tₙ. If the pressure regulation parameter changes at historical moments t₂ and t₉, and the cooling parameter changes at historical moments t₄ and t₂₀ within the acquisition time period t₁-tₙ, the historical adjustment time points include t₂, t₄, t₉ and t₂₀.

In some embodiments, for a cluster of sensing speed data, the processor determines the plurality sets of sensing speed data by performing intra-cluster grouping on the cluster of sensing speed data based on the historical adjustment time points within the acquisition time period corresponding to the cluster of sensing speed data.

For example, referring to the Table (3), if the acquisition time period corresponding to a first cluster of sensing speed data is t₁-t₅, and the pressure regulation parameter changes at a moment t₂ and the cooling parameter changes at a moment t₄ during an acquisition time period t₁-t₅, the first cluster of sensing speed data is divided into three sets of sensing speed data corresponding to time periods t₁-t₂, t₂-t₄, and t₄-t₅ based on the historical adjustment time points t₂ and t₄.

In some embodiments, the processor determines the plurality sets of sensing statistical data based on the plurality sets of sensing speed data through statistical analysis calculation. More descriptions regarding the specific calculation processes may be found in the related descriptions of the step S13.

In some embodiments of the present disclosure, by performing reasonable intra-cluster grouping on the sensing speed data based on the historical adjustment time points of the pressure regulation parameter and cooling parameter, the statistical results of the sensing speed data become more accurate.

In some embodiments, the processor determines a plurality of fluctuation results corresponding to the plurality sets of sensing speed data; determines a plurality of confidence levels of the plurality sets of sensing speed data based on the plurality of fluctuation results; and determines a plurality sets of sensing statistical data after filtration based on the plurality of confidence levels.

The fluctuation result refers to data characterizing a fluctuation of a set of sensing speed data. In some embodiments, a set of sensing speed data corresponds to a fluctuation result which may be represented by a variance or a standard deviation of the set of sensing speed data.

Merely by way of example, referring to the Table (4), if the sensing speed data of the time period t₁-t₃ in the first cluster of sensing speed data is groped to Set 1 of Cluster 1 after intra-cluster grouping, the set of sensing speed data includes v₁₂, v₂₃, wr₁₂, wr₂₃, ws₁₂, and ws₂₃. The standard deviation of the historical pressure change rates v₁₂ and v₂₃, the standard deviation of the historical gas temperature change rates ws₁₂ and wr₂₃, and the standard deviation of the historical device temperature change rates ws₁₂ and ws₂₃ are calculated, respectively, and a weighted sum of the three standard deviations is calculated and taken as the fluctuation result of the set of sensing speed data.

The confidence level refers to a measure characterizing the reliability of data. In some embodiments, the confidence level is represented by a numerical value.

In some embodiments, the confidence level is negatively correlated with the fluctuation result, and the larger the fluctuation result, the lower the confidence level. For example, the processor determines a reciprocal of the fluctuation result of a set of sensing speed data as the confidence level of the set of sensing speed data.

In some embodiments, for each cluster of sensing speed data, the processor may filter out one or more sets of sensing speed data of which confidence levels are less than a preset confidence threshold, and determine the plurality sets of sensing statistical data after filtration based on one or more sets of sensing speed data of which confidence levels are not less than the preset confidence threshold. The process of determining the sensing statistical data based on the sensing speed data may be found in the related descriptions of the step S13.

In some embodiments, the preset confidence threshold is a fixed value defaulted by the processor or set by those skilled in the art based on experience, or determined by the processor based on the confidence level. For example, for a cluster of sensing speed data, the processor determines an average confidence level of all sets of sensing speed data in the cluster as the preset confidence threshold of the cluster.

In some embodiments of the present disclosure, by determining the fluctuation result corresponding to the sensing speed data reflecting the fluctuation of the sensing speed data and further filtering the sensing speed data based on the confidence level by determining the confidence level based on the fluctuation result, it can help eliminate abnormal or unreliable data caused by occasional factors such as equipment failures or environmental interference, thereby retaining highly reliable sensing statistical data to improve the accuracy of subsequent analysis and decision.

In some embodiments of the present disclosure, by determining the sensing speed data based on the historical sensing data and further performing clustering and intra-cluster grouping on the sensing speed data based on the historical sensing data or the sensing speed data, the plurality sets of sensing statistical data of the plurality sets of sensing speed data can be accurately determined, which reflects the statistical situation of each set of historical sensing data, and facilitates accurate determination of the adjustment instruction.

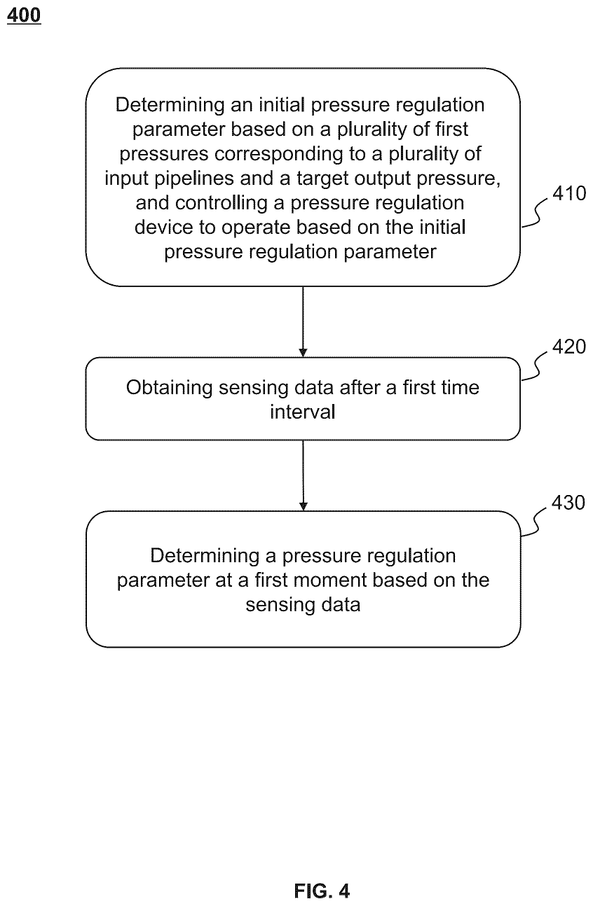

FIG. 4 is a flowchart illustrating an exemplary process of determining a pressure regulation parameter at a first moment according to some embodiments of the present disclosure. As shown in FIG. 4, a process 400 includes the following steps 410-430. In some embodiments, the process 400 is performed by the gas company management platform 131. For example, the process 400 is performed by the processor in the gas company management platform 131.

In some embodiments, the gas equipment object platform further includes a plurality of input pipelines of a gas pressure regulation station. A pressure regulation device may include a distribution device, a pressurization device, and/or a depressurization device. The pressure regulation parameter may include a distribution parameter of the distribution device, a pressurization parameter of the pressurization device, and/or a depressurization parameter of the depressurization device.

The distribution parameter refers to an operation parameter of the distribution device for controlling a gas flow direction. For example, gas from an input pipeline L₁ and an input pipeline L₂ is mixed and distributed to the pressurization device. As another example, if gas pressure differences among the plurality of input pipelines are too large for direct mixing, the gas from the input pipeline L₁ is distributed to the depressurization device and the gas from the input pipeline L₂ is distributed to the pressurization device for depressurization and pressurization, respectively, and then mixed, and mixed gas subsequently undergoes multi-stage cyclic pressurization before re-entering the pressurization device.

The pressurization parameter refers to an operation parameter of the pressurization device, such as a compressor power, a motor speed, a pressurization valve opening, a pressurization inlet flow rate, etc. The pressurization device may contain a plurality of compressors for different pressurization requirements. The compressor power refers to an operation power of the compressor. The larger the compressor power, the faster the pressurization of the pressurization device. The motor speed refers to a count of rotations of a motor rotor per unit time, and the faster the motor speed, the faster the pressurization of the pressurization device. The pressurization valve opening refers to an opening degree of a pressure regulation valve in the pressurization device. In some embodiments, the larger the pressurization valve opening, the larger the opening degree of the pressure regulation valve, and the faster the pressurization. The pressurization inlet flow rate refers to a flow rate of gas entering the pressurization device. The faster the pressurization inlet flow rate, the slower the pressurization of the pressurization device.

The depressurization parameter refers to an operation parameter of the depressurization device, such as a depressurization valve opening, a depressurization inlet flow rate, etc. The depressurization inlet flow rate refers to a flow rate of gas entering the depressurization device. The faster the depressurization inlet flow rate, the slower the depressurization of the depressurization device. The depressurization valve opening refers to an opening degree of a pressure regulation valve in the depressurization device. In some embodiments, the larger the depressurization valve opening, the larger the opening degree of the pressure regulation valve, and the faster the depressurization.

Step 410, determining an initial pressure regulation parameter based on a plurality of first pressures corresponding to a plurality of input pipelines and a target output pressure, and controlling a pressure regulation device to operate based on the initial pressure regulation parameter.

The target output pressure refers to an expected gas pressure after regulation by the pressure regulation device.

In some embodiments, the target output pressure is preset by those skilled based on experience.

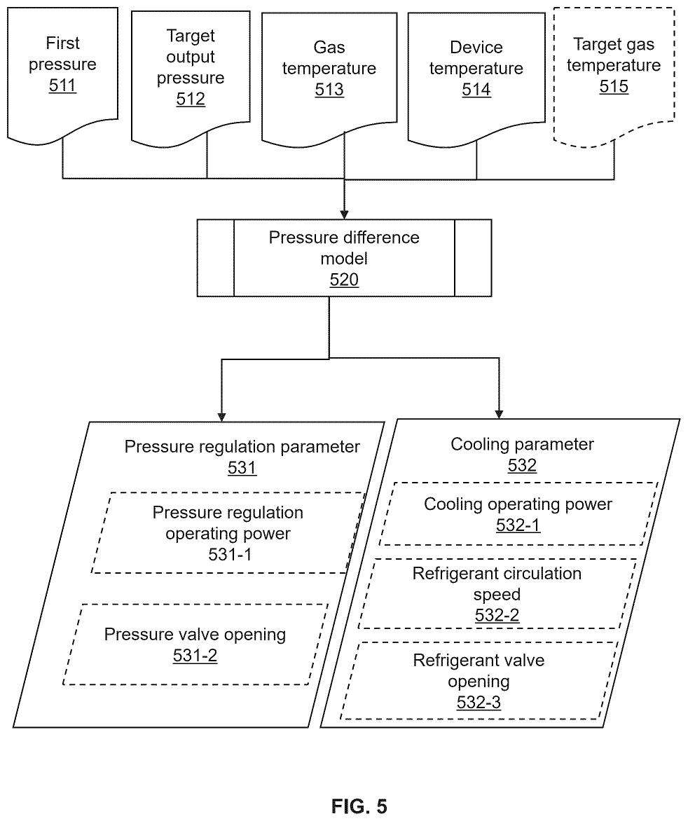

In some embodiments, the target output pressure is determined by the processor based on a gas demand of an output pipeline. More descriptions may be found in FIG. 5 and related descriptions thereof.

In some embodiments, each input pipeline corresponds to a first pressure, and the first pressure represents a gas pressure of gas of each input pipeline before regulation of the pressure regulation device. More descriptions regarding obtaining the first pressure may be found in the step 210 of FIG. 2.

The initial pressure regulation parameter refers to an initial value of the pressure regulation parameter for system startup or adjustment. In some embodiments, the initial pressure regulation parameter includes an initial distribution parameter, an initial pressurization parameter, and an initial depressurization parameter. For example, the initial pressure regulation parameter is expressed as [(input pipeline L₁ to the depressurization device, input pipeline L₂ to the pressurization device), (compressor power P₁ of a compressor 1, motor speed R, pressurization valve opening K₁, pressurization inlet flow rate E₁), (depressurization valve opening K₂, depressurization inlet flow rate E₂).

In some embodiments, the processor determines the initial distribution parameter based on the plurality of first pressures and the target pressure through a first preset rule; and determines the initial pressurization parameter and the initial depressurization parameter through a first preset algorithm.

The first preset rule and the first preset algorithm may be preset by those skilled in the art. For example, the first preset rule is that if the first pressure of the input pipeline is greater than a target gas pressure, the gas of the input pipeline is distributed to the depressurization device; if the first pressure of the input pipeline is less than the target gas pressure, the gas of the input pipeline is distributed to the pressurization device. The first preset algorithm may determine a ratio of the first pressure of the gas of the input pipeline distributed to the pressurization device to the target gas pressure as a compression ratio, calculate the compressor power based on the compression ratio, or determine the depressurization valve opening based on the first pressure of the gas of the input pipeline distributed to the depressurization device and the target gas pressure. The depressurization valve opening is positively correlated with a difference between the first pressure and the target gas pressure. The larger the difference between the first pressure and the target pressure corresponds, the greater the depressurization valve opening.

In some embodiments, the processor controls operation of the pressure regulation device based on the initial pressure regulation parameter.

Step 420, obtaining sensing data after a first time interval.

The first time interval refers to a time interval for determining whether a parameter needs significant adjustment.

In some embodiments, the first time interval is correlated with the difference between the first pressure and the target output pressure. The larger the difference between the first pressure and the target output pressure, the longer the first time interval.

In some embodiments, different gas pressure regulation stations correspond to the same or different first time intervals, the first time interval being correlated with a count of the input pipelines of the gas pressure regulation station.

In some embodiments, the processor determines the first time interval by querying a first preset table. The first preset table may include a correspondence between the count of the input pipelines of the gas pressure regulation station and the first time interval. For example, the larger the count of the input pipelines of the gas pressure regulation station, the longer the first time interval. The first preset table may be constructed by those skilled in the art based on the historical data and prior experience.

In some embodiments of the present disclosure, adjusting the first time interval based on the count of the input pipelines facilitates flexible adaptation to gas pressure regulation stations of various scales and complexities, thereby significantly enhancing the overall efficiency and stability of gas pressure regulation.

In some embodiments, the first time interval is further correlated with a second time interval, the first time interval being longer than the second time interval.

The second time interval refers to a time interval for determining whether a parameter needs minor adjustment.

In some embodiments, the processor determines whether the pressure regulation parameter and the cooling parameter need adjustment based on the sensing data after the first time interval, and determines whether a refrigerant circulation speed in the cooling parameter needs adjustment based on the sensing data after the second time interval, the first time interval being longer than the second time interval.

The first time interval and the second time interval may have no sequential relationship. For example, the first time interval precedes the second time interval. As another example, the second time interval is included within the first time interval.

In some embodiments, the second time interval is determined by querying a second preset table. More descriptions may be found in the present disclosure below.

In some embodiments of the present disclosure, only the refrigerant circulation speed is adjusted based on the second time interval, and the pressure regulation parameter and the cooling parameter are adjusted as a whole based on the first time interval, so that the second time interval is considered when the first time interval is determined, and the first time interval is set to be longer than the second time interval, making the first time interval more reasonable and reliable.

In some embodiments, a sensing device monitors and obtains sensing data after the first time interval from the current moment, and uploads the sensing data to the gas company management platform through the gas company sensor network platform. The processor may directly retrieve the sensing data after the first time interval.

Step 430, determining a pressure regulation parameter at a first moment based on the sensing data.

The first moment refers to a time point after the first time interval from the current moment.

In some embodiments, the processor determines the pressure regulation parameter at the first moment based on the sensing data after the first time interval. More descriptions regarding the process of determining the pressure regulation parameter based on the sensing data may be found in the related descriptions in the step S230 of FIG. 2, which are not repeated here.

In some embodiments of the present disclosure, the gas pressure regulation station incorporates a plurality of devices into the IoT, realizing precise coordination between the pressure regulation and the cold energy recovery device. The gas company management platform determines the initial pressure regulation parameter based on the first pressure of the plurality of input pipes and the target output pressure, and continuously monitors system changes by obtaining and analyzing the sensing data after the first time interval, so as to re-determine the pressure regulation parameter, thereby ensuring that the pressure regulation parameter meets the real-time requirements, and improving the stability and efficiency of the system operation.

In some embodiments, the cold energy recovery device further includes an expansion refrigeration device connected with the depressurization device. The cooling parameter may further include a refrigerant valve opening of the expansion refrigeration device. The gas company management platform may be further configured to: determine the cooling parameter at the first moment based on the sensing data after the first time interval and the initial pressure regulation parameter. More descriptions regarding the initial pressure regulation parameter may be found in the related descriptions of the step 410.

More descriptions regarding the cold energy recovery device, the expansion refrigeration device, and the cooling parameter may be found in the related descriptions of FIGS. 1-2.

The refrigerant valve opening refers to an opening degree of a valve for controlling a refrigerant flow rate. The refrigerant valve opening may be expressed as a percentage. For example, the refrigerant valve opening of 100% indicates that the valve for controlling the refrigerant flow rate is fully open, while the refrigerant valve opening of 50% indicates that the valve for controlling the refrigerant flow rate is half open. The larger the refrigerant valve opening, the faster the refrigeration speed of the expansion refrigeration device.

In some embodiments, the processor may determine the cooling parameter at the first moment based on the sensing data after the first time interval and the initial pressure regulation parameter through a second preset algorithm. The second preset algorithm may be preset by those skilled in the art. For example, the second preset algorithm is that a temperature reduction value is calculated based on the depressurization inlet flow rate of the depressurization device, the first pressure of the gas of the input pipeline distributed to the depressurization device, and the gas temperature using mathematical models such as an ideal gas equation. The temperature reduction value may be positively correlated with the refrigerant valve opening. The temperature reduction value refers to a temperature decrease of the gas after passing through the gas pressure regulation station. The larger the temperature reduction value, the more the cold energy is released during depressurization. Accordingly, a larger refrigerant flow is required to absorb the cold energy, and thus the refrigerant valve opening is larger.

In some embodiments of the present disclosure, the expansion refrigeration device can utilize the cold energy released during depressurization for cooling, and by directly connecting the expansion refrigeration device to the depressurization device, energy conservation can be achieved. The cooling parameter includes the refrigerant valve opening, which can precisely control the refrigerant flow to regulate the cooling process. By analyzing the sensing data after the first time interval and the initial pressure regulation parameter, the cooling parameter at the first moment can be accurately determined, which is conducive to timely and precise parameter adjustment of the cold energy recovery device.

In some embodiments, the processor determines the target output pressure based on the gas demand of the output pipeline; determines the pressure regulation parameter and the cooling parameter of a future time period through a pressure difference model based on the plurality of first pressures corresponding to the plurality of input pipelines, the target output pressure, and the gas temperature, the pressure difference model being a machine learning model.

The gas demand refers to data related to a gas demand of downstream users connected to the output pipeline, such as gas transportation pressures of the downstream users during various time periods.

The gas transportation pressure refers to an input pressure of gas during gas usage of the downstream users. The downstream users refer to users receiving gas through the output pipeline, such as a residential building, an office complex, etc. The various time periods may be divided in a plurality of forms, such as 24 hours of every day within each season.

In some embodiments, the processor directly retrieves the gas demand uploaded by the gas equipment object platform.

In some embodiments, the target output pressure includes target output pressures of a plurality future moments. For example, if the current moment is 12:00 on Sep. 20, 2024, the target output pressure includes target output pressures of 13:00, 14:00, and 15:00 on Sep. 20, 2024. Correspondingly, the target output pressure may be expressed in a sequence format, such as [(T₁, f₁), (T₂, f₂) . . . , (T_{g}, f_{g})], where T₁, T₂, . . . , T_{g} represent 1st, 2nd, . . . , g-th future moments, and f₁, f₂, . . . , f_{g} represent the target output pressures at the 1st, 2nd, . . . , g-th future moments.

In some embodiments, the processor determines the target output pressure of the future moment by statistical analysis based on the gas demand of the output pipeline. For example, the processor counts gas transportation pressures during 14:00-15:00 for each day in the autumn of 2023 (which is divided into August 23rd to November 20th according to meteorology) based on the gas demand of the output pipeline, and determines an average value of the gas transportation pressures as the target output pressure of the future moment of 15:00 on Sep. 20, 2024.

The pressure difference model refers to a model for determining the pressure regulation parameter and the cooling parameter for the future time period. In some embodiments, the pressure difference model may be a machine learning model, such as a Recurrent Neural Network (RNN).

FIG. 5 is schematic diagram illustrating an exemplary pressure difference model according to some embodiments of the present disclosure.

In some embodiments, as shown in FIG. 5, an input to a pressure difference model 520 includes one or more first pressures 511 corresponding to one or more input pipelines at a current moment, a target output pressure 512, a gas temperature 513, and a device temperature 514, and an output to the pressure difference model 520 includes a pressure regulation parameter 531 and a cooling parameter 532 of a future time period.

The pressure regulation parameter 531 may include a pressure regulation operation power 531-1 and a pressure valve opening 531-2. The cooling parameter 532 may include a cooling operation power 532-1 and a refrigerant circulation speed 532-2.

For example, if the current moment is T₀ and the target output pressure is [(T₁, f₁), (T₂, f₂) . . . , (T_{g}, f_{g})], the pressure difference model outputs the pressure regulation parameter and the cooling parameter of the future time periods as [T₀-T₁(P*₀₁, K*₀₁), T₁-T₂(P*₁₂, K*₁₂), . . . , T_{g-1}-T_{g}(P*_{(g-1)g}, K*_{(g-1)g})] and [T₀-T₁(P*₀₁, K*₀₁), T₁-T₂(P*₁₂, K*₁₂), . . . , T_{g-1}-T_{g}(P*_{(g-1)g}, K*_{(g-1)g})], respectively, where T_{g} represents a g-th future moment, T_{g-1}-T_{g} represents a g-th future time period, T_{g-1}-T_{g}(P_{(g-1)g}, K_{(g-1)g}) represents the pressure regulation parameter of the g-th future time period, P_{(g-1)g} and K_{(g-1)g} respectively represent the pressure regulation operation power and the pressure valve opening of the g-th future time period; T_{g-1}-T_{g}(P*_{g-1)g}, K*_{(g-1)g}) represents the cooling parameter of the g-th future time period, and P*_{g-1)g} and K*_{(g-1)g} respectively represent the cooling operation power and the refrigerant circulation speed of the g-th future time period.

More descriptions regarding data including the first pressure, the target output pressure, the gas temperature, the device temperature, the pressure regulation parameter, the cooling parameter, the pressure regulation operation power, the pressure valve opening, the cooling operation power, and the refrigerant circulation speed may be found in the related descriptions of FIGS. 2-4.

In some embodiments, the pressure difference model may be trained based on a plurality of training samples. A training sample may include a plurality of sample first pressures corresponding to a plurality of sample input pipelines at a sample moment, a sample gas temperature, a sample device temperature, and a sample target output pressure. A training label corresponding to the training sample may include an actual pressure regulation parameter and an actual cooling parameter of a sample time period. The sample time period is a time period consisting of a plurality of future moments from the sample moment.

In some embodiments, the training samples and the training labels may be selected by the processor from the historical data based on a second preset rule. The second preset rule may be preset by those skilled in the art. For example, the second preset rule may include the following step S31-step S32:

Step S31, obtaining a plurality of candidate training samples and corresponding candidate training labels based on historical data.

In some embodiments, each candidate training sample includes the first pressures, the second pressures, the gas temperatures, and the device temperatures at two candidate moments, and the corresponding candidate training label includes the pressure regulation parameter and the cooling parameter during a candidate time period.

The candidate moment may be a historical moment, and the candidate time period may be a time period defined by two candidate moments as start and end points. During the candidate time period between the two candidate moments, the pressure regulation parameter and the cooling parameter may remain constant, indicating that no historical adjustment time points are included in the candidate time period. More descriptions regarding the historical adjustment time points may be found in the related descriptions of FIG. 3.

Step S32, determining efficiency scores of the candidate training samples, and selecting candidate training samples of which the efficiency scores are greater than a preset score threshold as the training samples.

The efficiency score refers to a ratio of an energy consumption to a pressure change. The energy consumption refers to a total energy consumption of the pressure regulation device and the cold energy recovery device. The energy consumption may include a device electricity consumption and a refrigerant replenishment. In some embodiments, the energy consumption is obtained based on monitoring data of a monitoring device. The monitoring device may include an electricity meter, a refrigerant replenishment monitor, etc.

The pressure change refers to a difference between the second pressure at an end candidate moment and the first pressure at a start candidate moment during the candidate time period.

The preset score threshold may be set by the processor or by those skilled in the art based on experience.

In some embodiments, the processor trains the pressure difference model based on a plurality of training samples with labels.

In some embodiments, the processor inputs the training samples into an initial pressure difference model, constructs a loss function based on output results of the initial pressure difference model and the training labels, iteratively updates parameters of the initial pressure difference model through the loss function, and completes training when a preset training condition (e.g., the loss function converges, or a count of iterations reaches a threshold) is met so as to obtain a trained pressure difference model.

In some embodiments, different training sample sets of the pressure difference model have different learning rates, the learning rates being determined based on confidence levels of the training sample sets.

In some embodiments, the processor divides the plurality of training samples into a plurality of sets based on historical adjustment time points. For example, when the plurality of training samples are obtained based on historical sensing data including a plurality of historical moments (T₀, T₁, . . . , T₁₀₀), T₄₁ being a historical adjustment time point of the pressure regulation parameter and T₅₁ being a historical adjustment time points of the cooling parameter, the training samples are divided into three sets of training samples with the sample moments being (T₀, T₁, . . . , T₄₀), (T₄₀, T₄₁, . . . , T₅₀), and (T₅₁, T₅₂, . . . , T₁₀₀), respectively.

In some embodiments, the processor determines a plurality of fluctuation results corresponding to the plurality sets of training samples; and determine a plurality of confidence levels of the plurality sets of training samples based on the plurality of fluctuation results. More descriptions may be found in the descriptions regarding determining the confidence level of the sensing speed data in the step 330 of FIG. 3, which are not repeated here.

In some embodiments, the processor and/or those skilled in the art divide the plurality of confidence levels of the plurality sets of training samples into intervals. For example, the processor and/or those skilled in the art divide the plurality of confidence levels of the plurality sets of training samples into equal confidence level intervals (0-10%), (10%-20%), (20%-30%), etc.

In some embodiments, the processor groups a plurality sets of training samples with confidence levels in the same confidence level interval into a training sample set, a plurality of confidence level intervals corresponding to a plurality of training sample sets.

In some embodiments, different training sample sets of the pressure difference model have different learning rates, a training sample set corresponds to a learning rate, and the learning rate of the training sample set is determined based on confidence level of the training sample set. For example, the learning rate of the training sample set is positively correlated with an average value of the confidence levels of all sets of training samples in the training sample set. For example, the learning rate (R) is calculated based on the following formula:

$$R = q * α \qquad ( 2 )$$

where R is the learning rate, q is a positive correlation coefficient, and α is the average value of the confidence levels.

In some embodiments of the present disclosure, different training sample sets are selected for training the pressure difference model, and different training sets have different learning rates. The learning rate is one of the key factors affecting model training speed and stability. By adjusting the learning rate based on the confidence level, the model can rapidly learn from the training sample sets with high confidence levels, thereby improving the reliability of the model.

In some embodiments, as shown in FIG. 5, the cooling parameter 532 further includes a refrigerant valve opening 532-3 of the expansion refrigeration device.

More descriptions regarding the refrigerant valve opening may be found in the related descriptions of FIG. 4.

In some embodiments, the training labels corresponding to the training samples of the pressure difference model include an actual pressure regulating parameter, an actual cooling parameter, and an actual refrigerant valve opening of a sample time period. More descriptions regarding obtaining the training labels may be found in the related descriptions above, which are not repeated here.

In some embodiments of the present disclosure, the refrigerant valve opening directly controls a flow rate and a pressure of a refrigerant in a refrigeration system, which in turn affects the refrigeration efficiency and the energy consumption. With precise calculation and output of the optimal refrigerant valve opening by the pressure difference model, the refrigeration system can operate efficiently under various conditions, thereby meeting the cooling demand while reducing the energy consumption.

In some embodiments, as shown in FIG. 5, the input to the pressure difference model 520 further includes a target gas temperature 515, and the cooling parameter output by the pressure difference model further includes a refrigerant circulation speed 523-2 corresponding to the target gas temperature 515.

The target gas temperature refers to an expected temperature of gas after the pressure regulation device. More descriptions regarding the refrigerant circulation speed may be found in the related descriptions of FIG. 2.

In some embodiments, the training samples of the pressure difference model further include a sample target gas temperature, and the training labels further include an actual refrigerant circulation speed under the sample target gas temperature corresponding to the training samples. In some embodiments, the processor trains the pressure difference model based on the plurality of training samples including the sample target gas temperature. The training process may be found in the present disclosure above, which is not repeated here.

In some embodiments of the present disclosure, incorporating the target gas temperature as the input to the pressure difference model enables accurate determination of the corresponding refrigerant circulation speed through the pressure difference model, which avoids issues of increased system pressure loss caused by excessive circulation speed or poor refrigeration effect caused by insufficient circulation speed, thereby optimizing the overall system refrigeration performance and enhancing system stability.

In some embodiments of the present disclosure, by comprehensively considering various data (e.g., the first pressures of the plurality of input pipelines, the gas temperatures, etc.), the pressure adjustment parameters and the cooling parameters of a plurality of future time periods can be accurately predicted in one step using the machine learning models, thereby facilitating proactive parameter adjustment, reducing energy waste, and improving gas transportation efficiency and economic benefits.

In some embodiments, the cooling parameter further includes the refrigerant circulation speed, and the processor obtains sensing data after a second time interval; in response to the sensing data meeting an adjustment condition, adjust the refrigerant circulation speed at the second moment, the adjustment condition including at least one of continuous rise of the device temperature, a fluctuation value of the second pressure exceeding a preset fluctuation threshold, or the gas temperature being higher than a preset gas temperature.

More descriptions regarding the sensing data, the cooling parameter, the refrigerant circulation speed, the device temperature, the second pressure, and the gas temperature may be found in the related descriptions of FIG. 2.

More descriptions regarding the second time interval may be found in the related descriptions of FIG. 4.

In some embodiments, different gas pressure regulation stations have different second time intervals. In some embodiments, the second time interval is correlated with the first pressure, a target output pressure, and a target gas temperature corresponds to the gas pressure regulation station.

More descriptions regarding the gas pressure regulation station, the first pressure, the target output pressure, and the target gas temperature may be found in the related descriptions of FIGS. 1-5.

In some embodiments, different gas pressure regulation stations have different target output pressures. For example, a gas pressure regulation station located at the beginning of a pressure regulation process has a relatively high target output pressure; a gas pressure regulation station located at the end of the pressure regulation process has a relatively low target output pressure.

In some embodiments, different gas pressure regulation stations have different target output pressures, and correspond to different second time intervals. The processor may determine the second time interval by querying a second preset table based on the first pressure, the target output pressure, and the target gas temperature corresponding to a current gas pressure regulation station. The second preset table may include the first pressures, the target output pressures, the target gas temperatures of a plurality of gas pressure regulation stations of and the corresponding second time intervals. The smaller the difference between the first pressure and the target output pressure and the higher the target gas temperature, the larger the second time interval. In some embodiments, the second preset table is constructed by those skilled in the art based on the historical data or experience.

In some embodiments of the present disclosure, an appropriate second time interval is determined based on the first pressure, the target output pressure, and the target gas temperature corresponding to the current gas pressure regulation station, so as to adjust the operation parameter of the device in time, and reduce the risk of failure in the gas pipeline network.

In some embodiments, the sensing data after the second time interval is obtained by the sensing device through monitoring, uploaded to the gas company management platform via the gas company sensor network platform. The processor may directly retrieve the sensing data after the second time interval.

The adjustment condition refers to a condition that the refrigerant circulation speed needs to be adjusted. In some embodiments, the adjustment condition includes at least one of the continuous rise of the device temperature, the fluctuation value of the second pressure exceeding the preset fluctuation threshold, or the gas temperature exceeding the preset gas temperature.

In some embodiments, the second time interval includes a plurality of time periods, one of the time periods corresponding to a device temperature change rate. The continuous rise of the device temperature means a proportion of a count of time periods where the device temperature change rate exceeding an average value of the device temperature change rates exceeds a proportion threshold. The average value of the device temperature change rates refers to an average value of device temperature change rates of all time periods within the second time interval. The proportion threshold may be a processor default setting or set by those skilled in the art based on historical experience, such as 80%.

In some embodiments, the second time interval includes a plurality of time points, one of the time points corresponding to one second pressure. The fluctuation value of the second pressure may be represented by a standard deviation or a variance of a plurality of second pressures of a plurality of time points within the second time interval.

In some embodiments, the processor determines the preset fluctuation threshold based on a historical second pressure in historical sensing data. For example, the processor selects a historical time period with the same duration as the second time interval, determines historical sensing data of the historical time period, calculate a standard deviation of a plurality of the historical second pressures in the historical sensing data, and determines the standard deviation as the preset fluctuation threshold. The fluctuation value of the second pressure exceeding the preset fluctuation threshold indicates a significant fluctuation of the second pressure, which requires timely adjustment of the refrigerant circulation speed.

The preset gas temperature refers to a gas temperature required for transporting gas to downstream users through the output pipeline. The gas temperature being higher than the preset gas temperature indicates an excessive gas temperature of gas passing through the gas pressure regulation station, which requires timely adjustment of the refrigerant circulation speed.

More descriptions regarding the device temperature change rate, the second pressure, and the gas temperature may be found in the related descriptions of FIG. 2.

More descriptions regarding the output pipeline and the downstream users may be found in the related descriptions of FIG. 5.

In some embodiments, when at least one of the following occurs: the continuous rise of the device temperature, the fluctuation value of the second pressure exceeding the preset fluctuation threshold, or the gas temperature exceeding the preset gas temperature, the processor determines that the sensing data after the second time interval meets the adjustment condition.

The second moment refers to a time point after the second time interval from the current moment.

In some embodiments, in response to the sensing data after the second time interval meeting the adjustment condition, the processor determines the refrigerant circulation speed at the second moment by retrieving a vector database.

The vector database may include a plurality of reference vectors and corresponding vector labels. The reference vectors may include reference sensing data of reference time periods, reference pressure regulation parameters, and reference cooling operation powers. The vector labels may include reference refrigerant circulation speeds corresponding to the reference vectors. More descriptions regarding the cooling operation power may be found in the related descriptions of FIG. 2.

In some embodiments, the vector database is constructed based on the historical data. For example, the processor calculates effect scores of the historical sensing data of the plurality of historical time periods, selects historical sensing data with the effect scores exceeding a score threshold as the reference sensing data, determines corresponding historical pressure regulation parameters and historical cooling operation powers as reference pressure regulation parameters and reference cooling operation powers, thereby determining the reference vectors. The vector labels corresponding to the reference vectors may include the historical refrigerant circulation speeds. The historical time periods may have the same duration as the second time interval.

The effect score refers to an evaluation score of the operation effect of the gas pressure regulation station. In some embodiments, the processor determines the effect score based on a device temperature rise score, a fluctuation score, a gas temperature score, and a pressure regulation score.

The device temperature rise score refers to a score of the device temperature change rate in the historical time period. In some embodiments, the device temperature rise score is negatively correlated with the device temperature change rate. The device temperature change rate may include positive and negative values, and the larger the device temperature change rate, lower the device temperature rise score. More descriptions regarding the device temperature change rate may be found in the related descriptions of FIG. 2 and FIG. 3.

The fluctuation score refers to a score of the fluctuation value of the second pressure in the historical time period. In some embodiments, the fluctuation score is negatively correlated with the fluctuation value of the second pressure. The larger the fluctuation value of the second pressure, the lower the fluctuation score. More descriptions regarding the fluctuation value of the second pressure may be found in the related descriptions above.

The gas temperature score refers to a score of the gas temperature change rate in the historical time period. In some embodiments, the gas temperature score is negatively correlated with the gas temperature change rate. The gas temperature change rate includes positive and negative values, and the larger the gas temperature change rate, the lower the gas temperature score. More descriptions regarding the gas temperature change rate may be found in the related descriptions of FIG. 2 and FIG. 3.

The pressure regulation score refers to a score of the pressure change rate in the historical time period. In some embodiments, the pressure regulation score is positively correlated with the pressure change rate. The larger the absolute value of the pressure change rate, the higher the pressure regulation score.

In some embodiments, the processor performs weighted summation of the device temperature rise score, the fluctuation score, the gas temperature score, and the pressure regulation score, and use a result of the weighted summation as the effect score. In the weighted summation, the pressure regulation score has a highest weight.

In some embodiments, the processor constructs a vector to be matched based on the sensing data after the second time interval, the pressure regulation parameter, and the cooling operating power, calculates a plurality of similarities between the vector to be matched and a plurality of reference vectors, and determines a vector label corresponding to a reference vector with the highest similarity as the refrigerant circulation speed at the second moment.

In some embodiments, the processor adjusts the adjustment condition based on a maintenance frequency of the gas pressure regulation station.

The maintenance frequency refers to a frequency of maintenance performed on equipment in the gas pressure regulation station, such as a maintenance frequency of the pipelines, the cold energy recovery device, and the pressure regulation device in the gas pressure regulation station.

In some embodiments, the maintenance frequency is obtained by the gas equipment object platform, uploaded to the gas company management platform through the gas company sensor network platform, and directly retrieved by the processor.

In some embodiments, for a gas pressure regulation station with a relatively high maintenance frequency, the processor determines a reduction percentage of the adjustment condition by querying a third preset table. The third preset table may include maintenance frequencies and corresponding reduction percentages of the adjustment condition.

The reduction percentage of the adjustment condition may include: a reduction percentage of the proportion threshold, a reduction percentage of the preset fluctuation threshold, and a reduction percentage of the preset gas temperature. For example, if the proportion threshold is 80% and the reduction percentage of the proportion threshold is 20%, an adjusted proportion threshold becomes 64%. The third preset table may be constructed by the processor and/or those skilled in the art based on the historical data or historical experience.

For a gas pressure regulation stations with a relatively high maintenance frequency, the processor may lower the adjustment condition by reducing the proportion thresholds, decreasing the preset fluctuation threshold, and lowering the preset gas temperature, thereby improving the adjustment accuracy to ensure timely adjustment of the refrigerant circulation speed when abnormal data occurs.

In embodiments of the present disclosure, by adjusting the adjustment condition based on the maintenance frequency of the gas pressure regulation station, the gas company management platform can determine the stricter adjustment condition when equipment has multiple issues. By adjusting the refrigerant circulation speed, the device temperature change rate, the second pressure, and the gas temperature are maintained at a relatively stable state, thereby achieving more precise control of gas output temperature and output pressure, and reducing gas transportation abnormalities.

In the embodiments of the present disclosure, after the pressure regulation parameter and the cooling parameter are adjusted, by monitoring the sensing data after the second time interval again, the operation effect of the pressure regulation device and the cold energy recovery device under the pressure regulation parameter and the cooling parameter after adjustment can be evaluated. In addition, the refrigerant circulation speed is adjusted based on the device temperature change rate, the fluctuation value of the second pressure, and the gas temperature variation rate in the sensing data, which facilitates timely response to abnormal situations and prevents abnormalities in the operation of gas pressure regulation.

One or more embodiments of the present disclosure provide a non-transitory computer-readable storage medium storing computer instructions. When a computer reads the computer instructions from the storage medium, the computer may execute the method of coordinated control of equipment for gas safety pressure regulation.

The embodiments described in the present disclosure are merely for illustration and explanation purposes only, and do not limit the scope of application of the present disclosure. For those skilled in the art, various modifications and changes can be made under the guidance of the present disclosure, and all such modifications and changes remain within the scope of the present disclosure.

In addition, certain features, structures, or characteristics of one or more embodiments of the present disclosure may be suitably combined.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

What is claimed is:

1. An Internet of Things (IoT) system of coordinated control of equipment for gas safety pressure regulation, comprising a government safety supervision management platform, a government safety supervision sensor network platform, a government safety supervision object platform, a gas company sensor network platform, and a gas equipment object platform, the government safety supervision object platform including a gas company management platform, the gas equipment object platform including a pressure regulation device and a cold energy recovery device, the pressure regulation device and the cold energy recovery device being provided with a sensing device, the pressure regulation device being disposed in a gas pressure regulation station; wherein
the gas company management platform is configured to:
obtain historical sensing data from the sensing device, the historical sensing data including sensing data at a plurality of historical moments, the sensing data including a first pressure before gas passes through the pressure regulation device, a second pressure after the gas passes through the pressure regulation device, a gas temperature, and a device temperature of the pressure regulation device;
determine a plurality sets of sensing statistical data based on the historical sensing data, the sensing statistical data including a pressure difference statistic and a temperature difference statistic; and
generate an adjustment instruction based on current sensing data and the sensing statistical data, the adjustment instruction being sent to the government safety supervision management platform and configured to adjust a cooling parameter of the cold energy recovery device and a pressure regulation parameter of the pressure regulation device.

2. The IoT system of claim 1, wherein the gas company management platform is further configured to:
determine sensing speed data based on the historical sensing data, the sensing speed data including pressure change rates and temperature change rates of a plurality of historical time periods;
determine one or more clusters of the sensing speed data by clustering the sensing speed data based on the historical sensing data or the sensing speed data;
determine the plurality sets of sensing statistical data by performing intra-cluster grouping on each cluster of the sensing speed data.

3. The IoT system of claim 1, wherein the gas company management platform is further configured to:
for each cluster of the sensing speed data:
determine a plurality sets of sensing speed data by performing intra-cluster grouping on the sensing speed data based on historical adjustment time points of the pressure regulation parameter and the cooling parameter;
determine the plurality sets of sensing statistical data based on the plurality sets of sensing speed data.

4. The IoT system of claim 3, wherein the gas company management platform is further configured to:
determine a plurality of fluctuation results corresponding to the plurality sets of sensing speed data;
determine a plurality of confidence levels of the plurality sets of sensing speed data based on the plurality of fluctuation results;
determine a plurality sets of sensing statistical data after filtration based on the plurality of confidence levels.

5. The IoT system of claim 1, wherein the gas equipment object platform further includes a plurality of input pipelines of the gas pressure regulation station, the pressure regulation device includes a distribution device, a pressurization device, and/or a depressurization device, the pressure regulation parameter includes a distribution parameter of the distribution device, a pressurization parameter of the pressurization device, and/or a depressurization parameter of the depressurization device, and the gas company management platform is further configured to:
determine an initial pressure regulation parameter based on a plurality of first pressures corresponding to a plurality of input pipelines and a target output pressure, and control the pressure regulation device to operate based on the initial pressure regulation parameter;
obtain the sensing data after a first time interval;
determine the pressure regulation parameter at a first moment based on the sensing data.

6. The IoT system of claim 1, wherein the cold energy recovery device further includes an expansion refrigeration device connected with the depressurization device, the cooling parameter further includes a refrigerant valve opening of the expansion refrigeration device, and the gas company management platform is further configured to:
determine the cooling parameter at the first moment based on the sensing data after the first time interval and the initial pressure regulation parameter.

7. The IoT system of claim 6, wherein different gas pressure regulation stations correspond to different first time intervals, the first time interval being related to a count of the input pipelines of the gas pressure regulation station.

8. The IoT system of claim 7, wherein the first time interval is further related to a second time interval, the first time interval being longer than the second time interval.

9. The IoT system of claim 5, wherein the gas company management platform is further configured to:
determine the target output pressure based on a gas demand of an output pipeline;
determine the pressure regulation parameter and the cooling parameter of a future time period through a pressure difference model based on the plurality of first pressures corresponding to the plurality of input pipelines, the target output pressure, and the gas temperature, the pressure difference model being a machine learning model.

10. The IoT system of claim 9, wherein different training sample sets of the pressure difference model have different learning rates, the learning rates being determined based on confidence levels of the training sample sets.

11. The IoT system of claim 9, wherein the cooling parameter output by the pressure difference model further includes the refrigerant valve opening of the expansion refrigeration device.

12. The IoT system of claim 9, wherein an input of the pressure difference model further includes a target gas temperature, and the cooling parameter output by the pressure difference model further includes a refrigerant circulation speed corresponding to the target gas temperature.

13. The IoT system of claim 1, wherein the cooling parameter further includes a refrigerant circulation speed, and the gas company management platform is further configured to:
obtain the sensing data after a second time interval;
adjust the refrigerant circulation speed at a second moment in response to the sensing data meeting an adjustment condition, the adjustment condition including at least one of: continuous rise of the device temperature, a fluctuation value of the second pressure exceeding a preset fluctuation threshold, or the gas temperature being higher than a preset gas temperature.

14. The IoT system of claim 13, wherein different gas pressure regulation stations correspond to different second time intervals, the second time interval being related to the first pressure, a target output pressure, and a target gas temperature corresponding to the gas pressure regulation station.

15. The IoT system of claim 13, wherein the gas company management platform is further configured to:
adjust the adjustment condition based on a maintenance frequency of the gas pressure regulation station.

16. A method of coordinated control of equipment for gas safety pressure regulation, implemented based on an Internet of Things (IoT) system of coordinated control of equipment for gas safety pressure regulation, wherein the IoT system includes a government safety supervision management platform, a government safety supervision sensor network platform, a government safety supervision object platform, a gas company sensor network platform, and a gas equipment object platform; the government safety supervision object platform includes a gas company management platform, the gas equipment object platform includes a pressure regulation device and a cold energy recovery device, the pressure regulation device and the cold energy recovery device are provided with a sensing device, the pressure regulation device is disposed in a gas pressure regulation station;
the method is implemented by the gas company management platform, comprising:
obtaining historical sensing data from the sensing device, the historical sensing data including sensing data at a plurality of historical moments, the sensing data including a first pressure before gas passes through the pressure regulation device, a second pressure after the gas passes through the pressure regulation device, a gas temperature, and a device temperature of the pressure regulation device;
determining a plurality sets of sensing statistical data based on the historical sensing data, the sensing statistical data including a pressure difference statistic and a temperature difference statistic; and
generating an adjustment instruction based on current sensing data and the sensing statistical data, the adjustment instruction being sent to the government safety supervision management platform and configured to adjust a cooling parameter of the cold energy recovery device and a pressure regulation parameter of the pressure regulation device.

17. The method of claim 16, wherein the determining a plurality sets of sensing statistical data based on the historical sensing data includes:
determining sensing speed data based on the historical sensing data, the sensing speed data including pressure change rates and temperature change rates of a plurality of historical time periods;
determining one or more clusters of the sensing speed data by clustering the sensing speed data based on the historical sensing data or the sensing speed data;
determining the plurality sets of sensing statistical data by performing intra-cluster grouping on each cluster of the sensing speed data.

18. The method of claim 16, wherein the gas equipment object platform further includes a plurality of input pipelines of the gas pressure regulation station, the pressure regulation device includes a distribution device, a pressurization device, and/or a depressurization device, the pressure regulation parameter includes a distribution parameter of the distribution device, a pressurization parameter of the pressurization device, and/or a depressurization parameter of the depressurization device, and the method further comprises:
determining an initial pressure regulation parameter based on a plurality of first pressures corresponding to a plurality of input pipelines and a target output pressure, and controlling the pressure regulation device to operate based on the initial pressure regulation parameter;
obtaining the sensing data after a first time interval;
determining the pressure regulation parameter at a first moment based on the sensing data.

19. The method of claim 16, wherein the cooling parameter further includes a refrigerant circulation speed, and the method further comprises:
obtaining the sensing data after a second time interval;
adjusting the refrigerant circulation speed at a second moment in response to the sensing data meeting an adjustment condition, the adjustment condition including at least one of: continuous rise of the device temperature, a fluctuation value of the second pressure exceeding a preset fluctuation threshold, or the gas temperature being higher than a preset gas temperature.

20. A non-transitory computer-readable storage medium, comprising computer instructions that, when read by a computer, direct the computer to implement the method of coordinated control of equipment for gas safety pressure regulation of claim 16.
